(19) United States
(12) Patent Application Publication
(10) Pub. No.: US 2011/0036001 A1
(43) Pub. Date: Feb. 17, 2011

(54) Monument flower bracket/saddle

(76) Inventor: Melissa Blair Aker, Max Meadows, VA (US)

Correspondence Address: Melissa Aker, 334 Apache Run, Max Meadows, VA, 24360, US

(21) Appl. No.: 12/583,196

(22) Filed: Aug. 17, 2009

(51) Int. Cl. A47G 7/00; F16M 13/02

(52) U.S. Cl. 47/41.12

(57) ABSTRACT

A monument floral holder that can be mounted to various widths of stones, and allows for flowers arrangements to maintain their position during most wind conditions. The bracket is designed in a way that it can be install and removed without damaging the monument. The bracket is aesthetically pleasing, and can be used repeatedly by the family members that maintain the flower at the cemetery.

### RELATED APPLICATIONS

The present application is related to U.S. Pat. No. 993433, issued Dec. 1, 1992, for FLOWER SUPPORT FOR TOMBSTONES, by Allen; Nolda R, included by reference herein.

The present application is related to U.S. Pat. No. 2,652,674, issued Sep. 1, 1953, by Lee, included by reference herein.

The present application is related to U.S. Pat. No. 3,185,113, issued May 1, 1965, by Nathan et al., included by reference herein.

The present application is related to U.S. Pat. No. 3,310,911, issued Mar. 1, 1967, by Bosner et al., included by reference herein.

The present application is related to U.S. Pat. No. 3,346,125, issued Oct. 1, 1967, by Miller et al., included by reference herein.

The present application is related to U.S. Pat. No. 3,511,461, issued May 1, 1970, by Clark, included by reference herein.

The present application is related to U.S. Pat. No. 4,640,045, issued Feb. 1, 1987, by Nesbitt et al., included by reference herein.

The present application is related to U.S. Pat. No. 4,836,485, issued Jun. 1, 1989, by Cooper, included by reference herein.

The present application is related to U.S. Pat. No. 5,072,542, issued Dec. 1, 1991, by Quackenbush, included by reference herein.

### FIELD OF THE INVENTION

The present invention relates to headstone monument flower arrangement brackets and, more particularly, to hold the flowers in a substantial position during windy conditions.

### BACKGROUND OF THE INVENTION

Ever since floral shop and family members have been placing flower arrangements to the top of the headstone monuments, there has been a need to securely fasten the arrangement without damaging the stone. In addition, it needs to be removed as so desired, but stable enough to with stand weather conditions. With current floral holders on the market the wind can simply lift the arrangement off of the monument, and blow it away. These arrangements are created at the experience of the family or friends of the deceased, and should be in tact until the desired time to remove or change out. With most cemeteries they prefer or require that arrangements not be placed on the ground in front of the monument due to the maintenance of the cemetery, and without built in floral vases on the monument the top mounting bracket/saddle was designed.

Initially, monument brackets were designed to hold floral arrangements to the top of monuments due to not having vases built into the monument itself. In defiance of the maxim, “keep it simple”, certain inventors have developed what is the most commonly used bracket on the market today that is used by florist and family members in constructed of a Styrofoam block that is attached to two oblong shaped hoops of wires that can bend to fit various sizes of monuments. The wires are of about ⅛″ diameter, shaped into a constant hoop with a opening of about 1-½″ to 2″. The wires have a rubber gasket to grip to the stone once it is bend into place.

Prior brackets/saddles with the grippers and the ability to bend the wire hoops to fit, they can not obtain enough grip to hold the arrangement in place during wind. Conventional brackets/saddles blow off the monuments and clutter the fence lines. The ones that are still mounted into their location usually has an alternative means of holding it in place, such as duct tape, tie downs, etc.

Heretofore, no device has been created to fulfill the need for of holder of holding the flowers in place until so desired to remove for replacing the arrangement with fresh flowers.

Moreover, no current approach addresses the problem of placing the arrangements to the monument securely, and without compromising the ascetics of the monument of floral arrangements.

### SUMMARY OF THE INVENTION

In accordance with the present invention, there is provided a monument floral holder that can be mounted to various widths of stones, and allows for flower arrangements to maintain their position during most wind conditions. The bracket is designed in a way that it can be install and removed without damaging the monument. The bracket is aesthetically pleasing, and can be used repeatedly by the family members that maintain the flowers at the cemetery.

It would also be advantageous to provide a bracket for monument floral arrangements that is sturdy, adjustable, and removable.

It would also be advantageous to provide a bracket that can be removed without damaging the monument, but could be reused.

It would also be advantageous to provide a bracket that does not require primitive ways of mounting the floral arrangements, such as duct tape.

It would further be advantageous to provide a bracket that can withstand harsh weather conditions without blowing away.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a left perspective view of a monument flower bracket/saddle in accordance with the invention;

FIG. 2 is a left perspective view of a monument flower bracket/saddle in accordance with the invention without the floral foam for flowers;

FIG. 3 is a front plan view of a monument flower bracket/saddle in accordance with the invention;

FIG. 4 is a top plan view of a monument flower bracket/saddle in accordance with the invention; and

FIG. 5 is a left plan view of a monument flower bracket/saddle in accordance with the invention.

For purposes of clarity and brevity, like elements and components will bear the same designations and numbering throughout the Figures.

### DESCRIPTION OF THE PREFERRED EMBODIMENT

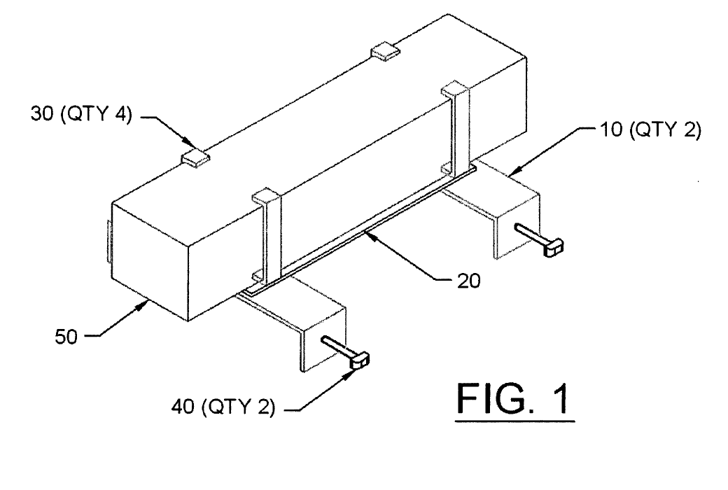

FIG. 1 is a perspective view of the monument floral bracket/saddle in accordance with the invention. A plate, item 20, is mounted between the two item 10 to the proper length. Item 30 is then mounted to the plate, item 20, to secure the floral foam 42, item 50. Item 40 is them screwed into the holes in the front leg of item 10.

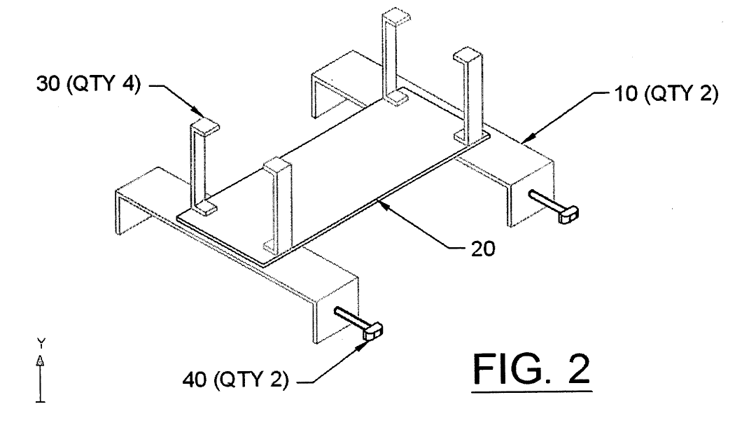

FIG. 2 is a perspective view of the monument floral bracket/saddle in accordance with the invention with out the floral foam 42 in place.

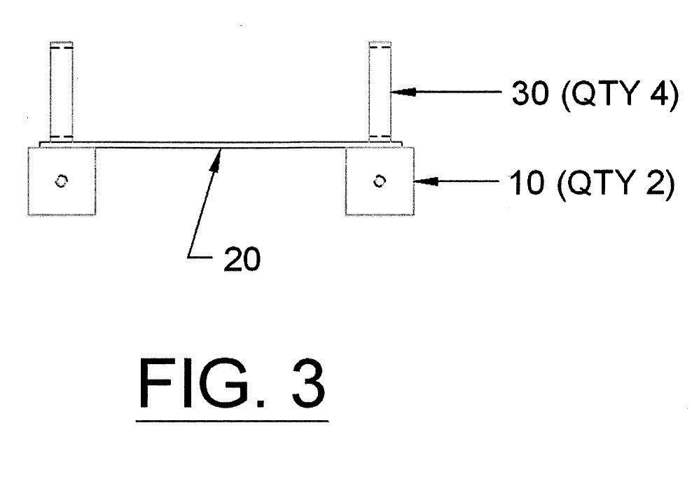

FIG. 3 is the front plan view of the monument floral bracket/saddle in accordance with the invention.

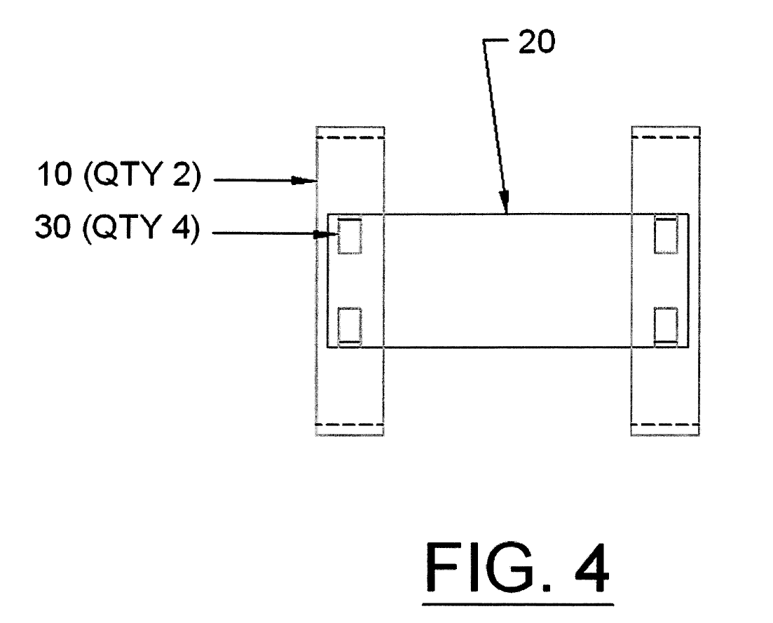

FIG. 4 is the top plan view of the monument floral bracket/saddle in accordance with the invention.

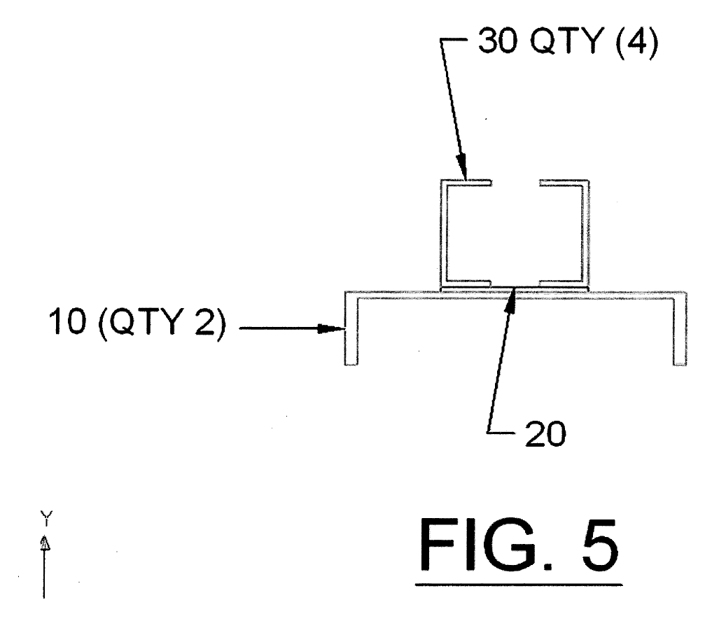

FIG. 5 is the left side plan view of the monument floral bracket/saddle in accordance with the invention.

Thus, is summary, it can be seen that what is provided in this invention is a monument floral bracket/saddle that is both functional, durable, and reusable. The over all length of the total assembly with floral foam 42 is 12 inches. Total weight is 2 pounds. Once the flowers are inserted into the foam the bracket/saddle virtually unseen to provide a more aesthetically pleasing object.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A monument flower bracket/saddle for to hold flower arrangements to the top of monument so that the wind will not blow the flower arrangement away, comprising:
means for mounting across top of monument;
means for aluminum plate to assemble the base channels, securely welded to said means for mounting across top of monument;
means for mouned to plate to hold floral foam in place, securely welded to said means for aluminum plate to assemble the base channels; and
means for plastic screws are used so not to damage monument, generally connected to said means for mouned to plate to hold floral foam in place.

2. The monument flower bracket/saddle in accordance with claim 1, wherein said means for mounting across top of monument comprises an aluminum channel.

3. The monument flower bracket/saddle in accordance with claim 1, wherein said means for aluminum plate to assemble the base channels comprises an aluminum plate.

4. The monument flower bracket/saddle in accordance with claim 1, wherein said means for mouned to plate to hold floral foam in place comprises a small aluminum channel.

5. The monument flower bracket/saddle in accordance with claim 1, wherein said means for plastic screws are used so not to damage monument comprises a plastic screws.

6. A monument flower bracket/saddle for to hold flower arrangements to the top of monument so that the wind will not blow the flower arrangement away, comprising:
an aluminum channel, for mounting across top of monument;
an aluminum plate, for aluminum plate to assemble the base channels, securely welded to said aluminum channel;
a small aluminum channel, for mouned to plate to hold floral foam in place, securely welded to said aluminum plate; and
a plastic screws, for plastic screws are used so not to damage monument, generally connected to said small aluminum channel.

7. The monument flower bracket/saddle as recited in claim 6, further comprising:
a floral foam, for floral foam to be added as needed to arrange the flowers, securely assembled to said aluminum channel.

8. A monument flower bracket/saddle for to hold flower arrangements to the top of monument so that the wind will not blow the flower arrangement away, comprising:
an aluminum channel, for mounting across top of monument;
an aluminum plate, for aluminum plate to assemble the base channels, securely welded to said aluminum channel;
a small aluminum channel, for mouned to plate to hold floral foam in place, securely welded to said aluminum plate;
a plastic screws, for plastic screws are used so not to damage monument, generally connected to said small aluminum channel; and
a floral foam, for floral foam to be added as needed to arrange the flowers, securely assembled to said aluminum channel.
